(19) United States
(12) Patent Application Publication
(10) Pub. No.: US 2022/0095308 A1
(43) Pub. Date: Mar. 24, 2022

(54) Technique for Sidelink Radio Communication

(71) Applicant: Telefonaktiebolaget LM Ericsson (publ), Stockholm (SE)

(72) Inventors: Shehzad Ali Ashraf, Aachen (DE); Wanlu Sun, San Diego, CA (US)

(21) Appl. No.: 17/421,437

(22) PCT Filed: Jan. 7, 2020
(86) PCT No.: PCT/EP2020/050224

§ 371 Date: Jul. 8, 2021

Related U.S. Application Data
(60) Provisional application No. 62/791,142, filed on Jan. 11, 2019.

(51) Int. Cl. H04W 72/06; H04B 7/06; H04W 72/04

(52) U.S. Cl. CPC H04W 72/06; H04B 7/0632; H04W 72/0406; H04B 7/0626

(57) ABSTRACT

Herein a technique for receiving and transmitting data on a sidelink, SL, is described. As to a method aspect of the technique, a method (300) of receiving data (608) on a SL between a receiving radio device (100) and a transmitting radio device (200) comprises or initiates a step of transmitting (302) a channel state information, CSI, report (604) on the SL to the transmitting radio device (200). The CSI report (604) comprises multiple rank indicators, RIs (606). Each of the RIs (606) is indicative of a rank for the SL. The method (300) of receiving data (608) on a SL further comprises a step of receiving (304) the data (608) from the transmitting radio device (200) on the SL using one of the indicated ranks (606) depending on a requirement of the data (608).

### TECHNICAL FIELD

The present disclosure generally relates to a technique for radio communication on a sidelink. More specifically, methods and devices are provided for transmitting and receiving data on a sidelink between radio devices.

### BACKGROUND

Radio communications terminated at a vehicle are referred to as vehicle-to-everything (V2X) communications and carry both non-safety and safety information. Therefore, the data of applications and services using the V2X communications is associated with a specific set of requirements, e.g., in terms of latency, reliability, capacity, etc. for transmitting V2X messages known as Common Awareness Messages (CAM) and Decentralized Notification Messages (DENM) or Basic Safety Message (BSM). For example, the packet size of some safety-related V2X messages is low compared to mobile broadband (MBB) communications but require high reliability, low latency and instant communication. Other V2X communications require a packet size for a video stream, e.g., for a platoon of trucks to enable a truck driver to “see through” the trucks in front.

V2X communication is an example for device-to-device (D2D) communication on sidelinks (SLs) introduced by the Third Generation Partnership Project (3GPP) in Releases 12 and 13 for Long Term Evolution (LTE), which was extended in Releases 14 and 15 to support V2X communication including any combination of direct communication between vehicles, pedestrians and infrastructure on the SLs. The D2D communications may take advantage of a network (NW) infrastructure, if available, but at least basic connectivity is possible even in case of lack of NW coverage.

Since the data of D2D applications and services, particularly in V2X communications, have diverse requirements, some data may benefit from a multi-antenna channel while multiple spatial streams may be adverse for other data.

### SUMMARY

Accordingly, there is a need for a sidelink radio communication technique that allows using multi-antenna systems flexibly and rapidly when needed.

As to a first method aspect, a method of receiving data on a sidelink (SL) between a receiving radio device and a transmitting radio device is provided. The method comprises or initiates a step of transmitting a channel state information (CSI) report on the SL to the transmitting radio device. The CSI report comprises multiple rank indicators (RIs). Each of the RIs is indicative of a rank for the SL. The method further comprises or initiates a step of receiving the data from the transmitting radio device on the SL using one of the indicated ranks depending on a requirement of the data.

The first method aspect may be implemented at and/or performed by the receiving radio device.

At least some embodiments of the technique enable the transmitting radio device to select one of the indicated ranks based on the data that is to be transmitted. The rank used for the data transmission may be selected out of the ranks indicated in the CSI report, wherein the selection depends on the requirement of the data that is to be transmitted. The transmitting radio device transmits the data using the selected rank. The receiving radio device receives the data using the selected rank.

In at least some embodiments, by transmitting the CSI report comprising multiple RIs, the receiving radio device can enable the transmitting radio device to flexibly and/or rapidly select any one of the indicated ranks for the transmission of the data. The selection may be flexible and/or rapid, e.g., because the selection is performed at the transmitting radio device that has knowledge of the requirement of the data to be transmitted and/or because no restriction or demand for the ranks (that are to be reported by the receiving radio device) has to be signaled to the receiving device in response to the data becoming available for transmission at the transmitting radio device. For example, the transmitting radio device may determine the requirement based on the data pending for the transmission at the transmitting radio device.

The CSI report transmitted from the receiving radio device to the transmitting radio device may define a set of different ranks by means of the multiple RIs. The data transmission from the transmitting radio device to the first radio device may use one of the different ranks in the set depending on the requirement (e.g., a set of requirements) associated with the data pending for transmission at the transmitting radio device. Based on the CSI report, the transmitting radio device may take the data-specific requirement into account for transmitting the data, e.g., a requirement for the transmission of the data, a property of the structure of the data and/or characteristics of D2D communications (e.g., inter-arrival times) of the data.

The receiving radio device may determine the CSI report based on CSI reference signals (CSI-RS) received or measured on the SL from the transmitting radio device.

Each of the indicated ranks may correspond to an optional rank or a rank candidate for the SL. Each of the indicated ranks may be selectable by the transmitting radio device for the transmission of the data. The receiving radio device may be capable of receiving the data using any one of the indicated ranks, e.g., according to a transmission mode (TM) that corresponds to the respective rank.

The multiple RIs in the CSI report (e.g., in a single and/or cohesive CSI report) may comprise different RIs (e.g., pairwise distinct RIs). At least some of the steps or the method may be repeated. For example, the receiving radio device may periodically transmit such CSI reports. Each of the at least one CSI report on the SL may comprise the pairwise distinct RIs. Alternatively or in addition, the rank used for the data transmission from the transmitting radio device over the SL to the receiving radio device may be one of the ranks indicated in the latest CSI report. For example, a rank that is not indicated in the latest CSI report may not be used for the data transmission.

The transmission of the data may be a multi-antenna transmission. The reception of the data may be a multi-antenna reception. The sidelink may comprise a data channel and a control channel. The data channel may be a multiple-input multiple-output (MIMO) channel, a single-input multiple-output (SIMO) channel, multiple-input single-output (MISO) channel or a single-input single-output (SISO) channel in accordance with the rank used for the data transmission. The CSI report may be transmitted on the control channel. The control channel may be a single-input single-output (SISO) channel independent of the rank used for the data transmission.

The used rank among the ranks indicated by the multiple RIs in the CSI report may depend on the data of a device-to-device (D2D) application or D2D service, particularly the data of a vehicle-to-everything (V2X) communication. By using the one rank of the indicated ranks depending on the data, the transmission and reception of the data may fulfill diverse requirements or a data-specific requirement, e.g., in terms of data rate, reliability, latency, packet size and/or inter-arrival time.

The technique may be implemented as a method of setting parameters for a CSI report on the SL. Each CSI report on the SL may comprise the multiple RIs and, optionally, their respectively associated one or more further CSI parameters, e.g., a precoding matrix indicator (e.g. PMI) and/or a channel quality indicator (e.g. CQI, or an indicator for a modulation scheme and/or a coding scheme). At least some of the one or more further CSI parameters (e.g., the PMI) associated with different RIs in the CSI report may be reported explicitly or implicitly.

The technique may be implemented in radio devices operative according to 5th Generation (5G) or New Radio (NR) networks, e.g., according to 3GPP Release 16, particularly for V2X communication.

In an LTE or NR implementation, the SL may use the PC5 interface defined by 3GPP.

At least one of the receiving radio device and the transmitting radio device may be connected or connectable to a radio access network (RAN). The SL may be assisted by the RAN, e.g., for cellular V2X (C-V2X) communications.

For example, in a scheduled mode (e.g., the “Mode 3” defined for 3GPP V2X communications), resource scheduling for the SL and/or interference configuration for the SL (e.g., the PC5 interface defined by 3GPP) may be assisted by the RAN (i.e., a base station of the RAN). The SL may be assisted via control signaling over the LTE-Uu interface.

In an autonomous mode (e.g., the “Mode 4” defined 3GPP), resource scheduling of the SL and interference control of the SL are supported based on distributed algorithms implemented between the transmitting radio device and the receiving radio device.

The multiple ranks indicated in the CSI report may comprise all ranks consistent with at least one of a rank capability of the receiving radio device; a rank capability of the transmitting radio device; and a rank restriction (e.g., defined by a configuration parameter) for the CSI report.

The rank capability of the receiving radio device may correspond to at least one of a number of antenna elements of the receiving radio device and a number of radio chains of the receiving radio device. The rank capability of the transmitting radio device may correspond to at least one of a number of antenna elements of the transmitting radio device and a number of radio chains of the transmitting radio device.

The rank restriction may be a restriction of the RIs comprised in the CSI report. The rank restriction may be defined by a configuration parameter of a configuration applied for the CSI report at the receiving radio device. The restriction may be defined by the configuration parameter of a protocol layer above the physical layer (PHY), the medium access control (MAC) layer or the radio link control (RLC) layer, e.g., a radio resource control (RRC) layer, at the receiving radio device.

Section 5.2.1.1 on reporting settings in the 3GPP document TS 38.214, e.g., version 15.3.0, specifies that an information element (IE) CSI-ReportConfig may also contain an IE CodebookConfig, which contains configuration parameters for Type-I or Type-II CSI including codebook subset restriction and/or for configurations of group-based reporting. The IE CodebookConfig (which may be transmitted in an RRC message) is defined in 3GPP TS 38.331, e.g., version 15.3.0, section 6.3.2 on RRC IEs, to configure codebooks of Type-I and Type-II (e.g., according to the 3GPP document TS 38.214, section 5.2.2.2), including codebook subset restriction.

The IE CodebookConfig is an example for a configuration comprising the configuration parameter. Examples for the configuration parameter defining the RI restriction comprise typeI-SinglePanel-ri-Restriction, typeII-PortSelectionRI-Restriction and typeII-RI-Restriction, or a combination thereof.

The configuration parameter may be implemented using a bit string. The i-th bit of the bit string may be indicative of whether or not RI=i+1 is excluded from CSI reporting (e.g., whether or not the rank indicated by RI=i+1 is excluded from preparing the CSI report and/or the transmission of the CSI report).

At least one of the rank capability of the receiving radio device; the rank capability of the transmitting radio device; and the rank restriction for the CSI report may be signaled by a radio access network (RAN).

The SL may be assisted by the RAN. For example, the RAN may control a configuration of the radio interface (e.g. PC5) of the SL.

The signaling from the RAN may use radio resource control (RRC) signaling. The signaling from the RAN may use a radio interface (e.g., the LTE-Uu interface) between the base station and the receiving radio device.

At least one of the rank capability of the receiving radio device; the rank capability of the transmitting radio device; and the rank restriction for the CSI report may be negotiated between the receiving radio device and the transmitting radio device during an establishing procedure for the SL.

The SL establishing procedure may comprise the transmitting radio device detecting the receiving radio device and/or the transmitting and receiving radio devices exchanging identifiers.

The SL may be a unicast link.

The requirement of the data may comprise, or relate to, at least one of a reliability of the data transmission; a data rate of the data transmission; a latency of the data transmission; a packet size of the data; and an inter-arrival time of the data at the transmitting radio device. The requirement of a packet size for the data may comprise at least one of a minimum size, a maximum size and an interval for the packet size of the data.

The method may further comprise a step of receiving SL control information (SCI) from the transmitting radio device. The SCI may be indicative of the rank among the indicated ranks, which is used for the data on the SL.

The CSI report may be further indicative of a set of one or more CSI parameters for the SL in association with at least one or each of the multiple RIs in the CSI report. Each set of one or more CSI parameters may comprise the one or more CSI parameters associated with the respective RI, i.e., the respectively indicated rank. Each set of one or more CSI parameters may correspond to a candidate or option for a transmission scheme that can be selected and/or used by the transmitting radio device for transmitting the data on the SL. For example, at least one or each of the one or more CSI parameters may correspond to a transmission parameter that can be selected and/or used by the transmitting radio device for transmitting the data on the SL. The transmission scheme may comprise one or more transmission parameters.

The SCI may be received after or in response to the transmission of the CSI report. The data and the SCI may be received in one self-contained transmission, e.g., in one transmission time interval (TTI).

Each of the RIs in the CSI report may be indicative of the rank for the SL in association with such a set of one or more CSI parameters (briefly: CSI parameter set). The data may be received on the SL according to the CSI parameter set associated with the rank used for the data transmission. Each of the CSI parameter sets may comprise one or more CSI parameters associated with the respectively indicated rank.

The CSI parameter associated with a first RI among the multiple RIs may be implicitly indicated by referring to the corresponding CSI parameter associated with a second RI among the multiple RIs. The second RI may be different from the first RI. The second RI may be greater than the first RI.

Each of the sets of one or more CSI parameters may be calculated conditioned on the respectively indicated rank. Herein, calculated may comprise estimating CSI parameters that maximize a data rate conditioned on an upper threshold of a block error rate (BER or BLER).

For each of the multiple RIs, the receiving radio device may calculate (e.g., estimate) the set of one or more CSI parameters conditioned on the respectively reported RI. For example, for each of the multiple RIs, the associated one or more CSI parameters may be calculated (e.g., estimated) conditioned on the respectively reported RI.

The one or more CSI parameters of one or each of the CSI parameter sets may comprise at least one of a precoding matrix indicator (PMI) and a channel quality indicator (CQI). The PMI and the CQI may be examples for the one or more CSI parameters. The PMI may be indicative of a precoding matrix, e.g., out of a precoding codebook. The CQI may be indicative of a modulation and coding scheme (MCS).

The PMI associated with a first RI among the multiple RIs may be implicitly indicated.

The PMI associated with the first RI may be implicitly indicated by referring to the PMI associated with a second RI among the multiple RIs. The second RI may be different from the first RI.

For example, the second RI may be greater than the first RI. A first precoder indicated implicitly in association with the first RI may be a subset (e.g., a column) of a second precoder indicated explicitly by the PMI associated with the second RI.

Each precoder may be represented by a corresponding precoding matrix. Each precoding matrix may be indicated by a corresponding PMI.

For each of the multiple RIs in the CSI report, the PMI and/or the CQI may be calculated conditioned on the respectively indicated rank (i.e., the respective RI). The receiving radio device may perform the calculation.

The one or more CSI parameters may comprise the PMI and/or the CQI, and the corresponding transmission parameter may comprise the precoding matrix indicated by the PMI and/or a modulation and MCS corresponding to the CQI, respectively.

In one variant, the transmitting radio device may use one or more transmission parameters for the data transmission, which correspond to the one or more CSI parameters associated with the rank used for the data transmission. For example, the data may be received on the SL according to the set of one or more CSI parameters associated with the rank used for the data transmission.

In another variant, the one or more transmission parameters used for the data transmission may deviate from (i.e., not correspond to) the one or more CSI parameters associated with the rank used for the data transmission. The sets of one or more CSI parameters associated with the respective RIs indicated in the CSI report may serve the transmitting radio device as a recommendation or suggestion from the receiving radio device. For example, the transmitting radio device may be embodied by a vehicle (e.g., a V-UE). Responsive to detecting a change in a driving direction or an orientation of the vehicle, the transmitting radio device may use a precoder corresponding to a beam than is wider than the beam corresponding to the precoder indicated in the CSI (i.e., the PMI) in association with the rank used for the data transmission. In another example, the transmitting radio device may increase the reliability of the data transmission by using an MCS that is more conservative than the MCS corresponding to the CQI indicated in the CSI in association with the rank used for the data transmission.

In any variant, the SCI may further be indicative of the one or more transmission parameters used for the data from the transmitting radio device on the SL.

The data transmission from the transmitting radio device may be a beamforming transmission on the SL and/or the reception of the data on the SL at the receiving radio device may be a beamforming reception, if the used rank is equal to 1. Alternatively or in addition, the data transmission and/or reception from the transmitting radio device to the receiving radio device on the SL may use a multiple-input multiple-output (MIMO) channel, if the used rank is greater than 1.

Furthermore, the data transmission may be a unicast, groupcast or multicast transmission.

The requirement of the data may comprise a requirement for a reliability of the data and/or a latency of the data (or the data transmission). The dependency of the rank used for the data transmission may be a non-increasing or decreasing function of the reliability and/or latency of the data.

Alternatively or in addition, the requirement of the data may comprise a requirement for a data rate and/or a packet size of the data. The dependency of the rank used for the data transmission may be a non-decreasing or increasing function of the data rate of the data and/or the packet size of the data.

As to a second method aspect, a method of transmitting data on a sidelink (SL) between a receiving radio device and a transmitting radio device is provided. The method comprises or initiates a step of receiving a channel state information (CSI) report on the SL from the receiving radio device. The CSI report comprises multiple rank indicators (RIs). Each of the RIs is indicative of a rank for the SL. The method further comprises or initiates a step of transmitting the data to the receiving radio device on the SL using one of the indicated ranks depending on a requirement of the data.

The second method aspect may be performed by the transmitting radio device.

The transmitting radio device may determine the requirement based on the data becoming available at the transmitting radio device for the transmission and/or in response to the data becoming available at the transmitting radio device for the transmission. For example, the transmitting radio device may determine the requirement and/or select the rank for the data transmission depending on the requirement after receiving the CSI report. Alternatively or in addition, the data to be transmitted may become available at the transmitting radio device after reception of the CSI report.

The second method aspect may further comprise any feature and/or any step disclosed in the context of the first method aspect, and vice versa.

Each of the first and second method aspects may be implemented as a method of CSI report configuration in the SL.

In any aspect, the technique may be implemented at two or more radio devices each acting as an embodiment of the receiving radio device and/or as an embodiment of the transmitting radio device, e.g. with or without coverage by a radio access network (RAN). For example, none, one or each of the two or more radio devices may be served by the RAN. The RAN may comprise one or more base stations or cells. A base station may encompass any station that is configured to provide radio access to the receiving radio device and/or the transmitting radio device.

The receiving radio device and/or the transmitting radio device may be configured for peer-to-peer or direct communication on the sidelink. Any of the receiving radio device and/or the transmitting radio device may be a user equipment (UE, e.g., a 3GPP UE), a mobile or portable station (STA, e.g. a Wi-Fi STA), a device for machine-type communication (MTC), a device for narrowband Internet of Things (NB-IoT) or a combination thereof. Examples for the UE and the mobile station include a mobile phone and a tablet computer. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in household appliances and consumer electronics. Examples for the combination include a self-driving vehicle, a door intercommunication system and an automated teller machine.

A radio access technology for the SL and/or the optional RAN may be implemented according to 3GPP Long Term Evolution (LTE), 3GPP New Radio (NR), and/or IEEE 802.11 (Wi-Fi). Examples for the optional base station may include a 4G base station or eNodeB, a 5G base station or gNodeB, and/or an access point (e.g., a Wi-Fi access point).

The technique may be implemented on a Physical Layer (PHY), a Medium Access Control (MAC) layer, a Radio Link Control (RLC) layer and/or a Radio Resource Control (RRC) layer of a protocol stack for the radio communication.

As to another aspect, a computer program product is provided. The computer program product comprises program code portions for performing any one of the steps of the first and/or second method aspect disclosed herein when the computer program product is executed by one or more computing devices. The computer program product may be stored on a computer-readable recording medium. The computer program product may also be provided for download via a data network, e.g., via the RAN, via the Internet and/or by the base station. Alternatively or in addition, the method may be encoded in a Field-Programmable Gate Array (FPGA) and/or an Application-Specific Integrated Circuit (ASIC), or the functionality may be provided for download by means of a hardware description language.

As to a first device aspect, a device for receiving data on a sidelink (SL) between a receiving radio device and a transmitting radio device is provided. The device is configured to perform the first method aspect. For example, the device may comprise units or modules configured to perform the respective steps.

As to a second device aspect, a device for transmitting data on a sidelink (SL) between a receiving radio device and a transmitting radio device is provided. The device is configured to perform the second method aspect. For example, the device may comprise units or modules configured to perform the respective steps.

As to a further first device aspect, a device for receiving data on a sidelink (SL) between a receiving radio device and a transmitting radio device is provided. The device comprises at least one processor and a memory. Said memory may comprise instructions executable by said at least one processor whereby the device is operative to perform the first method aspect.

As to a further second device aspect, a device for transmitting data on a sidelink (SL) between a receiving radio device and a transmitting radio device is provided. The device comprises at least one processor and a memory. Said memory may comprise instructions executable by said at least one processor whereby the device is operative to perform the second method aspect.

As to a still further aspect, a user equipment (UE) configured to communicate with another UE and/or a base station is provided. The UE comprises a radio interface and processing circuitry configured to execute any of the steps of the first and/or the second method aspect.

As to a still further aspect, a communication system including a host computer is provided. The host computer may comprise a processing circuitry configured to provide user data, e.g., the data in the data transmission. The host computer may further comprise a communication interface configured to forward user data to a cellular network (e.g., the RAN) for transmission to a user equipment (UE). The UE may comprise a radio interface and processing circuitry. The processing circuitry of the UE may be configured to execute any one of the steps of the first and/or the second method aspect.

The communication system may further include any of the UEs. Alternatively or in addition, the cellular network may further include one or more of the base stations configured to communicate with any of the UEs.

The processing circuitry of the host computer may be configured to execute a host application, thereby providing the user data. Alternatively or in addition, the processing circuitry of any of the UEs may be configured to execute a client application associated with the host application.

As to a still further aspect, a method implemented in a user equipment (UE) is provided. The method may comprise any of the steps of the first and/or the second method aspect.

The devices, the transmitting radio device, the receiving radio device, the UEs, the communication system or any terminal, node or station for embodying the technique may further include any feature disclosed in the context of the first or second method aspect, and vice versa. Particularly, any one of the units and modules, or a dedicated unit or module, may be configured to perform or trigger one or more of the steps of any one of the method aspects.

### BRIEF DESCRIPTION OF THE DRAWINGS

Further details of embodiments of the technique are described with reference to the enclosed drawings, wherein:

FIG. 1 shows a schematic block diagram of an embodiment of a device for receiving data on a sidelink between a receiving radio device and a transmitting radio device;

FIG. 2 shows a schematic block diagram of an embodiment of a device for transmitting data on a sidelink between a receiving radio device and a transmitting radio device;

FIG. 3 shows a schematic flowchart for an implementation of a method of receiving data on a sidelink between a receiving radio device and a transmitting radio device, which method is implementable by the device of FIG. 1;

FIG. 4 shows a schematic flowchart for an implementation of a method of transmitting data on a sidelink between a receiving radio device and a transmitting radio device, which method is implementable by the device of FIG. 2;

FIG. 5 schematically illustrates an exemplary environment for embodying the devices of FIGS. 1 and 2 as well as for implementing the methods of FIGS. 3 and 4;

FIG. 6 schematically illustrates a signaling diagram for first embodiments of the devices of FIGS. 1 and 2;

FIG. 7 schematically illustrates a signaling diagram for second embodiments of the devices of FIGS. 1 and 2;

FIG. 8 schematically illustrates a signaling diagram for third embodiments of the devices of FIGS. 1 and 2;

FIG. 9 schematically illustrates a signaling diagram for fourth embodiments of the devices of FIGS. 1 and 2;

FIG. 10 shows a schematic block diagram of an embodiment of the device of FIG. 1;

FIG. 11 shows a schematic block diagram of an embodiment of the device of FIG. 2;

FIG. 12 schematically illustrates a telecommunication network connected via an intermediate network to a host computer;

FIG. 13 shows a generalized block diagram of a host computer communicating via a base station with a user equipment over a partially wireless connection; and

FIGS. 14 and 15 show flowcharts for methods implemented in a communication system including a host computer, a base station and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented in any other radio network, including 3GPP LTE or a successor thereof, and Wireless Local Area Network (WLAN) according to the standard family IEEE 802.11.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

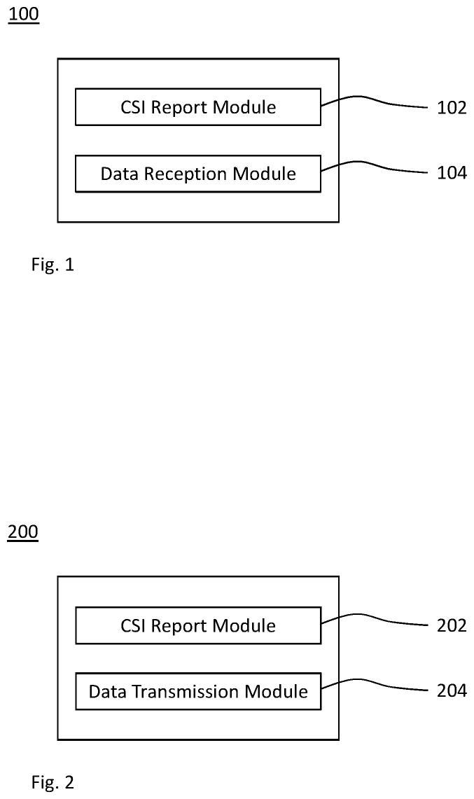

FIG. 1 schematically illustrates a block diagram of a device for receiving data on a sidelink (SL) between a receiving radio device and a transmitting radio device. The device is generically referred to by reference sign 100.

The device 100 comprises a CSI report module 102 that transmits a channel state information (CSI) report on the SL to the transmitting radio device. The CSI report comprises multiple rank indicators (RIs). Each of the RIs is indicative of a rank for the SL. The device 100 further comprises a data reception module 104 that receives the data transmitted from the transmitting radio device on the SL using one of the indicated ranks depending on a requirement of the data.

Any of the modules of the device 100 may be implemented by units configured to provide the corresponding functionality.

The device 100 may be the receiving radio device. The receiving radio device 100 may be configured for multi-antenna reception. For example, the receiving radio device 100 may comprise multiple antenna elements for diversity combining or multi-layer reception according to the rank used for the data transmission.

FIG. 2 schematically illustrates a block diagram of a device for transmitting data on a SL between a receiving radio device and a transmitting radio device. The device is generically referred to by reference sign 200.

The device 200 comprises a CSI report module 202 that receives a CSI report on the SL from the receiving radio device. The CSI report comprises multiple RIs. Each of the RIs is indicative of a rank for the SL. The device 200 further comprises a data transmission module 204 that transmits the data to the receiving radio device on the SL using one of the indicated ranks depending on a requirement of the data.

Any of the modules of the device 200 may be implemented by units configured to provide the corresponding functionality.

The device 200 may be the transmitting radio device. The transmitting radio device 200 may be configured for multi-antenna transmission. For example, the transmitting radio device 200 may comprise multiple antenna elements for beamforming transmission or multi-layer transmission according to the rank used for the data transmission.

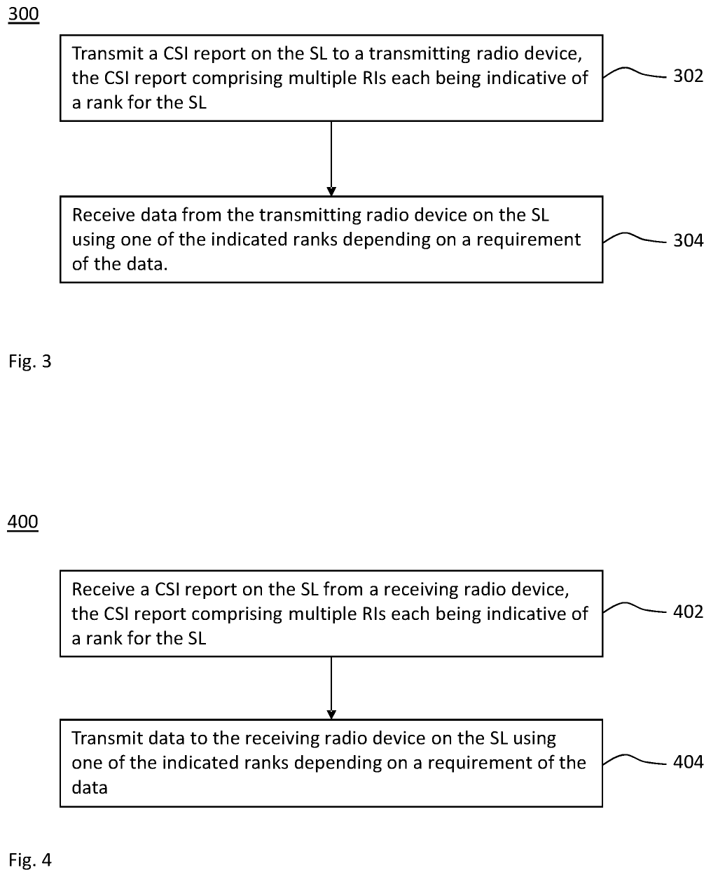

FIG. 3 shows a flowchart for a method 300 of receiving data on a SL between a receiving radio device and a transmitting radio device. In a step 302 of the method 300, a CSI report is transmitted on the SL to the transmitting radio device. The CSI report comprises multiple RIs. Each of the RIs is indicative of a rank for the SL. The data transmitted from the transmitting radio device on the SL is received using one of the indicated ranks depending on a requirement of the data in a step 304.

The method 300 may be performed by the device 100, e.g., at or using the receiving radio device 100 for communicating with and/or accessing the transmitting radio device 200. For example, the modules 102 and 104 may perform the steps 302 and 304, respectively.

FIG. 4 shows a flowchart for a method 400 of transmitting data on a SL between a receiving radio device and a transmitting radio device. In a step 402 of the method 400, a CSI report is received on the SL from the receiving radio device. The CSI report comprises multiple RIs. Each of the RIs is indicative of a rank for the SL. The data is transmitted to the receiving radio device on the SL using one of the indicated ranks depending on a requirement of the data in a step 404.

The method 400 may be performed by the device 200, e.g., at or using the transmitting radio device 200 for communicating with and/or accessing the receiving radio device 100. For example, the modules 202 and 204 may perform the steps 402 and 404, respectively.

Any aspect of the technique may be implemented by a method of setting CSI report parameters for the SL. More specifically, each CSI report on the SL may comprise multiple RIs, and optionally their respectively associated one or more CSI parameters, e.g., values for PMI and/or CQI.

In any aspect, the radio devices 100 and 200 may be embodied by radio devices configured for wireless ad hoc connections, i.e., SLs. Each of the radio devices 100 and 200 may be embodied by a vehicle, e.g., configured for radio-connected driving. For example, the transmitting radio device 100 and the receiving radio device 200 may be respectively embodied by road vehicles wirelessly connected or connectable with each other over the SL.

Furthermore, the radio devices 100 and 200 may be wirelessly connected or connectable to a RAN. That is, each of the radio devices 100 and 200 may be configured for accessing the RAN. The RAN may comprise a base station, e.g., a network controller such as a Wi-Fi access point or a radio access node such as a 4G eNodeB or a 5G gNodeB of the RAN. The base station may be configured to provide radio access to the receiving radio device 100 and/or transmitting radio device 200.

Each of the radio devices 100 and 200 may be embodied by a mobile or portable station, a user equipment (UE), a device for machine-type communication (MTC) and/or a device for (e.g., narrowband) Internet of Things (NB-IoT). At least one embodiment of the receiving radio device 100 and at least one embodiment of the transmitting radio device 200 may be configured to wirelessly connect to each other over the SL, e.g., in an ad hoc radio network and/or a mesh network.

Embodiments of the radio devices 100 and 200 may be configured for stand-alone radio communication, ad hoc radio networks and/or vehicular radio communications (V2X), particularly according to technical standard documents of the Third Generation Partnership Project (3GPP). In Release 12, the 3GPP standard for Long Term Evolution (LTE) had been extended with support of device-to-device (D2D) communications, which is an example of the SL.

3GPP D2D features are also referred to as Proximity Services (ProSe) and enable both commercial and Public Safety applications. ProSe features enabled since 3GPP LTE Release 12 include device discovery. For example, one of the radio devices 100 and 200 may sense the proximity of the respectively other radio device. Furthermore, an associated application may broadcast and/or detect discovery messages that carry device identities and/or application identities. Further ProSe features enable direct communication based on physical channels terminated directly between radio devices 100 and 200. Such features are defined, inter alia, in the documents 3GPP TS 23.303, Version 15.1.0, and 3GPP TS 24.334, Version 15.2.0.

In 3GPP LTE Release 14, the D2D communications were further extended to support of V2X communications, which include any combination of direct communication between vehicles, pedestrians and infrastructure. While V2X communications may take advantage of a network infrastructure (e.g., the RAN) if available, at least basic V2X connectivity is possible even in case of lacking RAN coverage. Implementing V2X communications based on a 3GPP radio interface (e.g., according to LTE or its successors) can be economically advantageous due to economies of scale. Furthermore, using or extending a 3GPP radio interface may enable a tighter integration between communications with the network infrastructure (V2I communications) and vehicular D2D communications (such as vehicle-to-pedestrian, V2P, and vehicle-to-vehicle, V2V, communications) as compared to using a dedicated V2X technology.

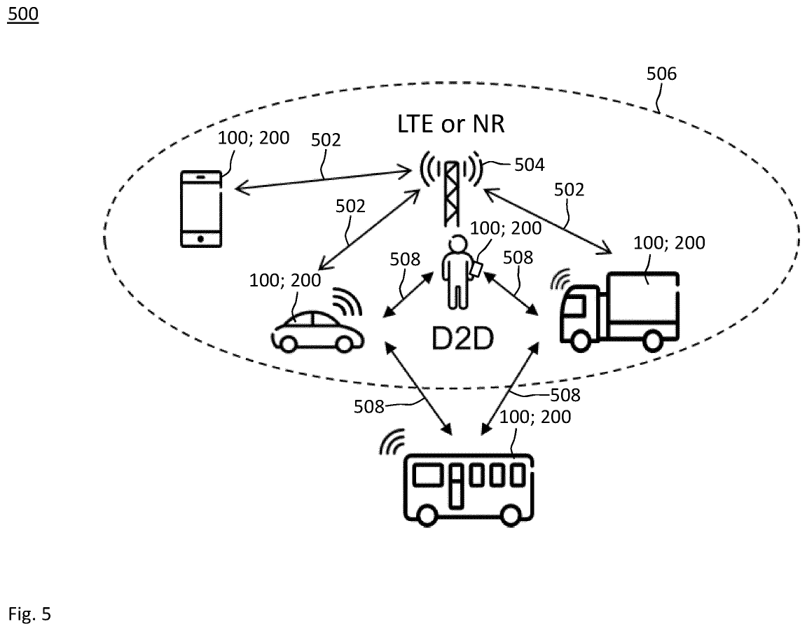

FIG. 5 schematically illustrates an exemplary radio environment 500 for implementing the technique. Embodiments of the radio devices 100 and 200 may or may not have a control channel 502 with the RAN (i.e., a network infrastructure) including at least one base station 504 (e.g., an eNB or a gNB) providing radio access within a cell 506. That is, the radio environment 500 includes the SLs 508 (e.g., for V2X communications) optionally without the need for a network infrastructure. The SLs 508 may be implemented using a PC5 interface. For example, the control channel 502 may include a Uu interface. Vehicle-to-vehicle communication (as an example of V2X communication) may be assisted by the base station 504 via control signaling over the Uu interface.

The data transmitted in the step 404 and received in the step 304 on the SL 508 (e.g., a V2X communication), may be associated with a specific requirement. The requirement may be a set of requirements on latency, reliability, capacity and/or Quality of Service. For example, V2X communications may carry both non-safety and safety information. The European Telecommunications Standards Institute (ETSI) has defined two types of messages for road safety, including a Co-operative Awareness Message (CAM) and a Decentralized Environmental Notification Message (DENM).

The CAM message enables vehicles, including emergency vehicles, to notify their presence and other relevant parameters (e.g., at least one of position and velocity) in a broadcast fashion. Such messages target other vehicles, pedestrians and infrastructure, and are handled by their applications. The DENM message is event-triggered, such as by braking and emergency detection.

As examples for the requirement associated with the data, the Technical Specification Group on Service and System Aspects (SA) in 3GPP (more specifically, the subgroup SA1 for Services) has defined service requirements for future V2X services in a “Study on Enhancement of 3GPP support for V2X services”. The subgroup SA1 has identified 25 use cases for advanced V2X services in 5G (i.e., LTE and NR). Such use cases are categorized into four use case groups. A first use case group encompasses vehicles platooning. A second use case group encompasses extended sensors. A third use case group encompasses advanced driving. A fourth use case group encompasses remote driving. In addition, direct unicast transmission over the SL will be needed in some use cases such as platooning, cooperative driving, dynamic ride sharing, video/sensor data sharing, etc. Therefore, future V2X use cases go beyond classical Intelligent Transportation Systems (ITS) services, i.e., such safety services with CAM/DENM type of transmissions.

In order to support advanced V2X use cases, the CSI report according to the present technique enables the transmitting radio device 200 to flexibly fulfill at least one of the following requirements associated with the data to be transmitted (e.g., in a NR V2X design). A first group of requirements associated with the data includes diverse requirements in terms of latency, reliability and/or data rate for different use cases. A second group of requirements associated with the data comprises traffic types with varying data properties including packet size and/or inter-arrival time (i.e., the arrival of data to be transmitted at the transmitting radio device 200).

The consolidated requirements for each use case group are captured in the 3GPP document TR 22.886, e.g., version 16.2.0, or in the 3GPP document TS 22.186, e.g., version 16.1.0. For these advanced applications, the expected requirements to meet the needed data rate, capacity, reliability, latency, communication range and speed are made more stringent. In order to meet at least some of these requirements, link adaption for the SL 508 may be implemented based on the CSI report of the present technique. Optionally, more HARQ processes, adaptive HARQ retransmissions for the SL 508 based on HARQ feedback and/or multi-antenna transmission schemes (e.g., similar to those for the cellular interface, i.e., the Uu interface 502) for the SL 508 may be applied. For example, more HARQ processes can facilitate a Stop-and-Wait (SAW) process for transmissions with more diverse requirements.

Conventional LTE V2X considers a single transmitting (Tx) antenna and has not specified multi-antenna transmission schemes (i.e., a radio communication using multiple antenna elements). In contrast, e.g., as a result of a study on evaluation methodology for NR V2X use cases documented in the 3GPP document TR 37.885, e.g., version 15.1.0, a vehicular UE (V-UE) may be equipped with up to 8 antenna elements for 6 GHz and up to 32 antenna elements for 30 GHz or 63 GHz.

A multi-antenna transmission can enhance reliability and/or data rate. For example, using a rank greater than 1 can enhance the data rate. Using a rank equal to or greater than 1 in a beamformed transmission 404 or a transmission 404 with spatial redundancy can enhance the reliability. The technique may be implemented for a more efficient unicast, closed-loop multi-antenna transmission 404 on the SL 508 and its associated CSI report. More specifically, the technique can allow the transmitting UE 200 to flexibly select any one of the ranks indicated in the CSI report depending on the data to be transmitted.

Furthermore, each of the multiple RIs in the CSI report may be associated with one or more CSI parameters. The one or more CSI parameters associated with any one of the multiple RIs are collectively referred to as a set of one or more CSI parameters (briefly: CSI parameter set). The CSI parameter set may correspond to a suggested transmission scheme. For example, the technique can allow the transmitting UE 200 to flexibly select any one of the ranks indicated in the CSI report, optionally in combination with the associated CSI parameter set (e.g., the corresponding transmission scheme), depending on the data to be transmitted. Since the RI may also be considered as a CSI parameter, the one or more CSI parameter associated with each RI may also be referred to as the one or more further CSI parameters.

Moreover, the CSI report on the SL 508, as transmitted in the step 302 and received in the step 402, may comprise at least some features defined for enhanced mobile broadband (eMBB) in NR Release 15 according to the 3GPP document TS 38.214, e.g., version 15.3.0.

A Channel Quality Indicator (CQI) is a first example for the one or more further CSI parameters. The CQI may be indicative of a modulation and coding scheme (MCS) preferred from the perspective of the receiving UE 100. A Precoder Matrix Indicator (PMI) is a second example for the one or more further CSI parameters. The PMI may be indicative of a precoder preferred from the perspective of the receiving UE 100. A Resource Indicator for the CSI-RS (CRI) is a third example for the one or more further CSI parameters. The CRI may be indicative of a beam preferred from the perspective of the receiving UE 100.

The receiving UE 100 may calculate the one or more further CSI parameters (if reported in each case) assuming predefined dependencies between the CSI parameters (if reported in each case). For example, the UE 100 may calculate the CQI conditioned on the reported PMI, RI and CRI. Alternatively or in addition, the UE 100 may calculate the PMI conditioned on the reported RI and CRI. Alternatively or in addition, the UE 100 may calculate the respective RI conditioned on the reported CRI.

The CSI parameter CRI may be used by some embodiments of the radio device 100, e.g., those operating according to LTE-Advanced (LTE-A) or 5G, to indicate a preferred beam, i.e. as part of Full Dimension Multiple-Input Multiple-Output (FD-MIMO) or Massive MIMO. The transmitting UE 200 may perform a beamformed CSI-RS operation, e.g., similar to class B Enhanced MIMO (eMIMO)-Type, with one or more CSI-RS resources. This operation may comprises schemes wherein CSI-RS ports have narrow beamwidths (at least at a given time and/or frequency) and, hence, no wide cell coverage, and (at least from the perspective of the transmitting UE 200) some CSI-RS port-resource combinations have different beam directions. The transmitting UE 200 may configure multiple beams per receiving UE 100 (e.g., a maximum number may be 8). The receiving UE 100 may feedback the CRI in the CSI report, which provides the known parameters PMI, RI and CQI on the preferred beam.

The multiple RIs in the CSI report may encompass any rank the receiving UE 100 believes is a suitable transmission rank, that is, a suitable number of transmission layers for the transmission 404 on the SL 508. In conventional NR eMBB, a UE reports only the highest possible rank.

For example, a (e.g., higher layer) configuration parameter (e.g., a bitmap parameter structured similarly to the configuration parameter typeI-SinglePanel-ri-Restriction) may exclude one or more RIs from being reported. The configuration parameter may form a bit sequence [r₇, . . . , r₁, r₀]. When rᵢ is zero, i ∈{0, 1, . . . , 7}, the multiple RIs (and, if reported, the associated PMI) are not allowed to correspond to any precoder associated with v=i+1 layers, e.g., analogously to the 3GPP document TS 38.214, e.g. version 15.3.0. For example, the multiple RIs in the CSI report may comprise two or more RIs (e.g., all RIs) not excluded by the configuration parameter(s). In contrast, conventional CSI reporting for NR eMBB (e.g., according to the 3GPP document TS 38.212, version) reports only one RI in that is the maximum possible transmission rank of the measured channel.

PMI is a CSI parameter that indicates what the receiving UE 100 has determined as a suitable precoder matrix from a (e.g., configured or pre-configured) codebook given the respectively associated rank RI.

CQI is a CSI parameter that indicates the (e.g., highest) MCS that, if used, would mean the transmission 404 on the SL 508 using the respectively associated RI and PMI would be received satisfying a predefined requirement on a block-error rate (BLER). The receiving UE 100 may determine the CQI to be reported based on measurements of reference signals (e.g., CSI-RSs) on the SL from the transmitting UE 200. For example, the receiving UE 100 determines the associated CQI such that it corresponds to the highest MCS allowing the receiving UE 100 to decode a transport block from the transmitting UE 200 with an error rate probability not exceeding 10%.

For concreteness and not limitation, embodiments of the technique are described in the context of V2X communications. The skilled person can readily apply these embodiments to other direct communications between UEs 100 and 200, e.g., in other scenarios involving D2D communications.

As stated above, in a conventional CSI report for NR eMBB, the RI is selected as the maximum possible transmission rank of the measured channel, on condition of satisfying the configured restriction (i.e., the higher layer parameter typeI-SinglePanel-ri-Restriction). However, since some V2X applications target high data rate (e.g., see-through video streams) while some other V2X applications (e.g., advanced driving) target high reliability, it is not beneficial to always report the maximum possible channel rank and its associated precoder. Moreover, due to the potentially varied packet size at the transmitting UE 200, which is unknown in advance, it will be hard or impossible for the receiving UE 100 to report the suitable rank and its associated precoder that perfectly match the (e.g., future) need of the transmit packet. To resolve at least some of the issues, embodiments of the technique enable flexibility at the transmitting UE 200 for selecting the rank (and optionally associated further CSI parameters) based on the CSI report comprising multiple RIs from the receiving UE 100.

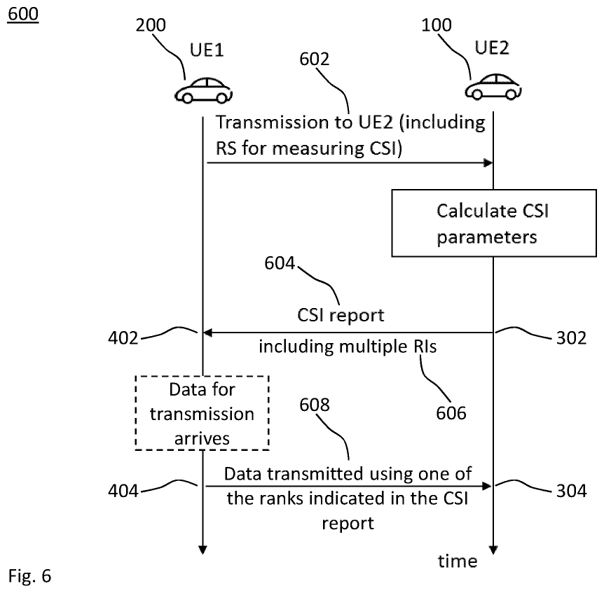

FIG. 6 schematically illustrates a signaling diagram 600 resulting from a first embodiment of the receiving UE 100 communicating over the SL 508 with a first embodiment of the transmitting UE 200. The UE1 is the transmitting UE 200 that intends to transmit to UE2, which is the receiving UE 100, e.g., in a unicast session. To improve the data transmission 404, UE2 100 reports CSI parameters in the CSI report 604 in advance, which are then used by UE1 200 to adjust its later transmission 404. Among the possible CSI parameters, the RI and at least one of PMI and CQI may be relevant.

Based on some prior transmission 602 from the transmitting UE 200 including reference signals (e.g., CSI-RSs), the receiving UE 100 may calculate CSI parameters for multiple ranks, which are indicated by the multiple RI 606, respectively, in the CSI report 604 transmitted in the step 302.

At the time of receiving 402 the CSI report 604, the data 608 to be transmitted may not have even become available at the transmitting UE 200. Based on the CSI report 604, the transmitting UE 200 selects the rank out of the multiple RIs depending on the requirement of the data to be transmitted. In the step 404, the selected rank is used for transmitting the data.

In the pair of first embodiments, the receiving UE 100 (e.g., the UE2 in FIG. 6) reports the multiple RIs in one CSI report, optionally on condition of satisfying a configured restriction. The configured restriction may be implemented in combination with any feature described for the other (e.g., third) embodiments.

For concreteness and not limitation, consider a scenario in which both the transmitting UE 200 and the receiving UE 100 are employed with 4 antenna elements. In some examples, the receiving UE 100 will report all the possible rank values, i.e., 1, 2, and 4, as well as their associated CQIs and PMIS (e.g., in combination with features described for the second embodiment). In some other examples, to reduce report overhead, the receiving UE 100 will only report a selected number of rank values, e.g., 1 and 2, as well as their associated CQIs and PMIS. The number of reported rank values can be configured during a connection establishment phase.

In any embodiment, the PMIS and CQIs may be reported in association with each of the multiple RIs.

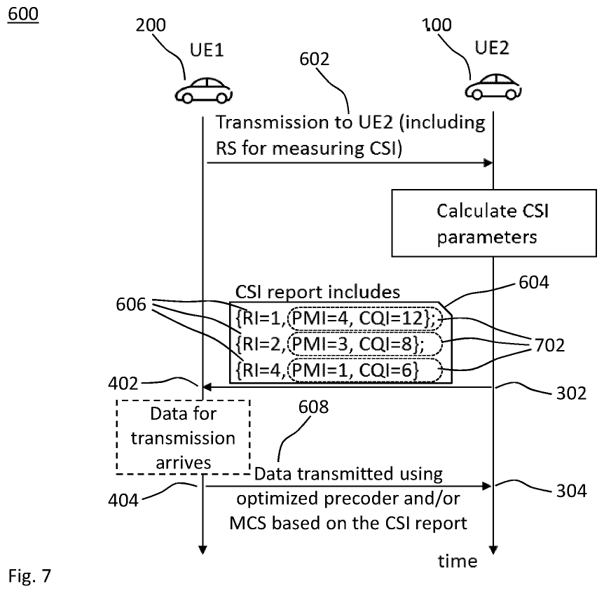

FIG. 7 schematically illustrates a signaling diagram 600 resulting from a second embodiment of the receiving UE 100 communicating over the SL 508 with a second embodiment of the transmitting UE 200. The second embodiments may be combined with any feature of the first embodiments.

The multiple RIs 606 are comprised in one CSI report 604 on the SL 508. Each of the multiple RIs is associated with a CSI parameter set 702, e.g., one value for the PMI and/or one value for the CQI. The receiving UE 100 calculates CSI parameters (if reported) assuming the following dependencies between CSI parameters (if reported). The CQI shall be calculated conditioned on the PMI and RI associated in the CSI report 604. The PMI shall be calculated conditioned on the RI associated in the CSI report 604.

While the second embodiment has been described with one CSI parameter set 702 associated with each of the multiple RIs 606, two or more CSI parameter sets 702 may also be associated with one of the multiple RIs 606 or each of two or more (e.g., all) of the multiple RIs 606.

In the second embodiments, within one CSI report 604, for each of the multiple RIs 606, the receiving UE 100 reports explicitly the respectively associated PMI(s) and/or CQI(s). In the example scenario underlying the second embodiments in FIG. 7, both the transmitting UE 200 and the receiving UE 100 are employed with 4 antenna elements. In some examples, as illustrated in FIG. 7, each RI 606 report is associated with one PMI value and one CQI value.

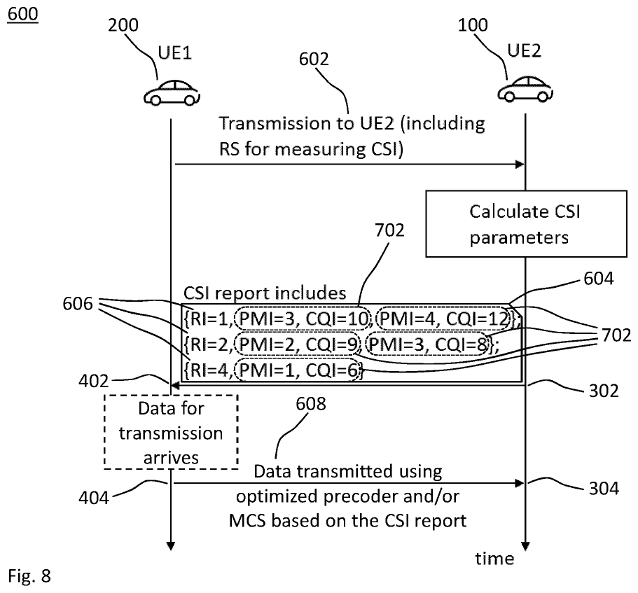

FIG. 8 schematically illustrates a signaling diagram 600 resulting from a third embodiment of the receiving UE 100 communicating over the SL 508 with a third embodiment of the transmitting UE 200. The third embodiments may be combined with any feature described in the context of the first or second embodiments.

The multiple RIs 606 are comprised in one CSI report 604 on the SL 508. Each of the multiple RIs 606 may be associated with one or multiple CSI parameter sets 702, e.g., multiple values for the PMI and/or multiple values for the CQI associated with the respective RI 606.

In the example illustrated in FIG. 8, each of the multiple RI 606 in the CSI report 604 may be associated with one or multiple values for the PMI and one or multiple values for the CQI values. In some other examples, each RI 606 in the CSI report 604 is only associated with a PMI report that may include one value or multiple values for the PMI associated with the respective RI 606. In some other examples, each RI 606 in the CSI report 604 is only associated with a CQI report that may include one value or multiple values for the CQI associated with the respective RI 606.

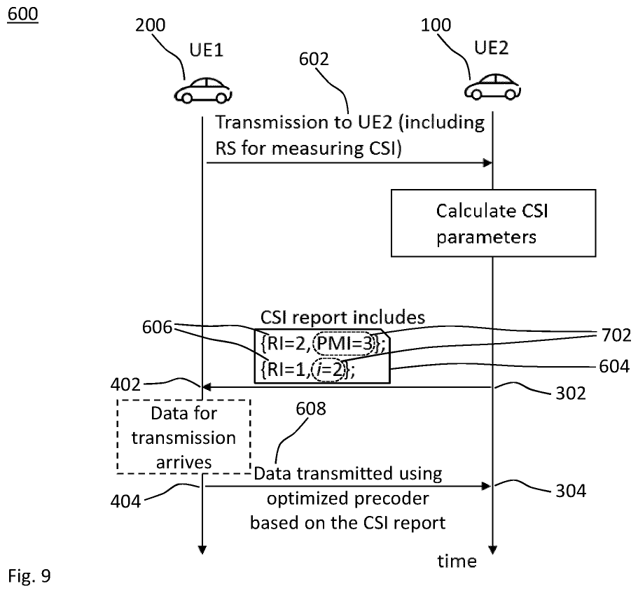

FIG. 9 schematically illustrates a signaling diagram 600 resulting from a fourth embodiment of the receiving UE 100 communicating over the SL 508 with a fourth embodiment of the transmitting UE 200. The fourth embodiments may be combined with any feature described in the context of the first, second or third embodiments.

The multiple RIs 606 are comprised in one CSI report 604 on the SL 508, wherein the value for the PMI associated with the respective RI 606 is reported in an implicit way.

Within one CSI report 604, the receiving UE 100 may report implicitly the values for the PMI associated with each of the multiple RIs 606.

The value for the PMI associated with a first rank (e.g., the highest rank) among the multiple RIs 606 is explicitly reported in the CSI report 604. The value for the PMI associated with a second rank, which is less than the first rank, among the multiple RIs 606 is implicitly reported in the CSI report 604 by referring to the precoder associated with the first rank.

By way of example, as illustrated in FIG. 9, the receiving UE 100 intends to report two rank values, e.g., RI=1 and RI=2, and their associated values for the PMI. For the first rank, RI=2, and its associated PMI, the receiving UE 100 reports {RI=2, PMI=3} in an explicit way. For the second rank, RI=1, and its associated PMI, the receiving UE 100 reports {RI=1, i=2}, where ‘i=2’ means the i-th (i.e., the 2-nd) column of the rank-2 precoder with PMI=3, i.e., the precoder determined by {RI=2, PMI=3}.

In another example, the receiving UE 100 may skip the report of ‘i=2’ as well. The absence of both an explicit value as well as a column reference may be interpreted as the reported precoder associated with the RI 606 is by default, configured or preconfigured a certain column (e.g., the first column) of the precoder associated with the first rank, i.e., of the precoder determined by {RI=2, PMI=3}.

To summarize, in fourth embodiments, the reported precoder associated with the second RI may depend on the one or more reported precoders associated with the first RI.

Any of the embodiments, particularly the above first to fourth embodiments, may be combined with a restriction of the multiple RI 606 comprised in the CSI report 604 (and associated reports or values for the CQI and/or PMI).

In one implementation of the restriction, there is a configured or pre-configured restriction on the number of reported RIs, i.e., the number of the multiple RIs 606 comprised in one CSI report 604. More specifically, a configuration parameter (also: restriction parameter, e.g., a higher layer parameter) may be indicative of certain ranks (i.e., certain values for the RI, and optionally for their associated one or more values for the PMI) that are not allowed to report, i.e., may not be comprised in the CSI report 604. For example, consider a scenario where both transmitting UE 200 and receiving UE 100 are employed with 8 antennas. In this example case, by virtue of the restriction parameter, the receiving UE 100 may only be allowed to report RIs up to 4 (e.g., and their associated PMIs).

In one variant, the restriction parameter is pre-configured. In another variant, the restriction parameter is configured during a unicast establishment procedure. In a further variant, the restriction parameter is configured by the network (e.g., the RAN).

Furthermore, a method embodiment of reporting RI and, optionally, its associated values for CQI and/or PMI, e.g., which of the first to fourth embodiment is applied, may be pre-configured, configured by the network (e.g., the RAN) or decided during the unicast establishment procedure.

Optionally, a selection of the multiple RIs 606 in CSI report 604 may further depend on applications supported during one unicast session. If only one type of application is expected during the unicast session, then only one RI and its corresponding PMI and/or CQI may be reported in CSI report. For example, the reported one RI is not necessarily the highest possible rank. Otherwise, the selection of the used rank based on the multiple RIs 606 comprised in the CSI report 604 is dependent on the requirement of the data (e.g., transmission requirements and/or data properties).

In an embodiment of the technique, based on the CSI report 604 from the receiving UE 100, the transmitting UE 200 (e.g., the UE1 in FIGS. 6 to 9), can select appropriate transmission parameters, including precoder and/or MCS, for the transmission 404 based on its own needs. For example, if the transmitting UE 200 intends to transmit a small packet with high reliability requirement, it select a rank1-precoder. On the other hand, if the transmitting UE 200 intends to transmit a large packet, it selects a rank2-precoder.

The above embodiments are described for the SL scenario in which the UEs 100 and 200 autonomously select SL transmission parameters. However, the methods 300 and 400 may be implemented and/or extended to a scenario in which the RAN (e.g., an eNB or a gNB) assigns the transmission parameters for SL 508 (or some of the transmission parameters) to the transmitting UE 200. In this case, the CSI parameters for the SL 508 comprised in the CSI report 604 may be directly reported from the receiving UE 100 to the RAN or the serving base station 504 (e.g., the gNB) or the CSI parameters for the SL 508 are reported from the receiving UE 100 to the RAN or the serving base station 504 (e.g., the gNB) via the transmitting UE 200 as a relay. It may also be possible that the CSI report 604 is transmitted only on the SL 508 according to the step 302, and the transmitting UE 200 selects these transmission parameters within restrictions provided by its serving base station (e.g., a gNB). The latter case may also be referred to as a partial network control.

While the SL communication has been described above as a SL unicast for simplicity, the technique is readily applicable and/or extendable to a SL multicast and/or a SL groupcast.

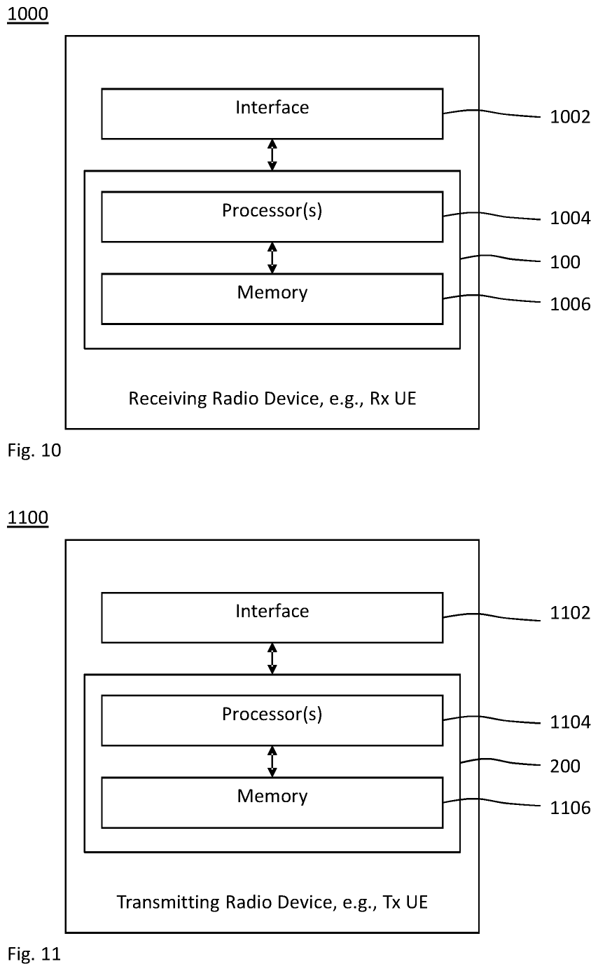

FIG. 10 shows a schematic block diagram for an embodiment of the device 100. The device 100 comprises one or more processors 1004 for performing the method 300 and memory 1006 coupled to the processors 1004. For example, the memory 1006 may be encoded with instructions that implement at least one of the modules 102 and 104.

The one or more processors 1004 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1006, radio device functionality and/or data receiver functionality. For example, the one or more processors 1004 may execute instructions stored in the memory 1006. Such functionality may include providing various features and steps discussed herein, including any of the benefits disclosed herein. The expression “the device being operative to perform an action” may denote the device 100 being configured to perform the action.

As schematically illustrated in FIG. 10, the device 100 may be embodied by a radio device 1000, e.g., functioning as a data receiver. The radio device 1000 comprises a radio interface 1002 coupled to the device 100 for radio communication with one or more radio devices and/or one or more base stations.

FIG. 11 shows a schematic block diagram for an embodiment of the device 200. The device 200 comprises one or more processors 1104 for performing the method 400 and memory 1106 coupled to the processors 1104. For example, the memory 1106 may be encoded with instructions that implement at least one of the modules 202 and 204.

The one or more processors 1104 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 1106, radio device functionality and/or data transmitter functionality. For example, the one or more processors 1104 may execute instructions stored in the memory 1106. Such functionality may include providing various features and steps discussed herein, including any of the benefits disclosed herein. The expression “the device being operative to perform an action” may denote the device 200 being configured to perform the action.

As schematically illustrated in FIG. 11, the device 200 may be embodied by a radio device 1100, e.g., functioning as a data transmitter. The radio device 1100 comprises a radio interface 1102 coupled to the device 200 for radio communication with one or more radio devices and/or one or more base stations.

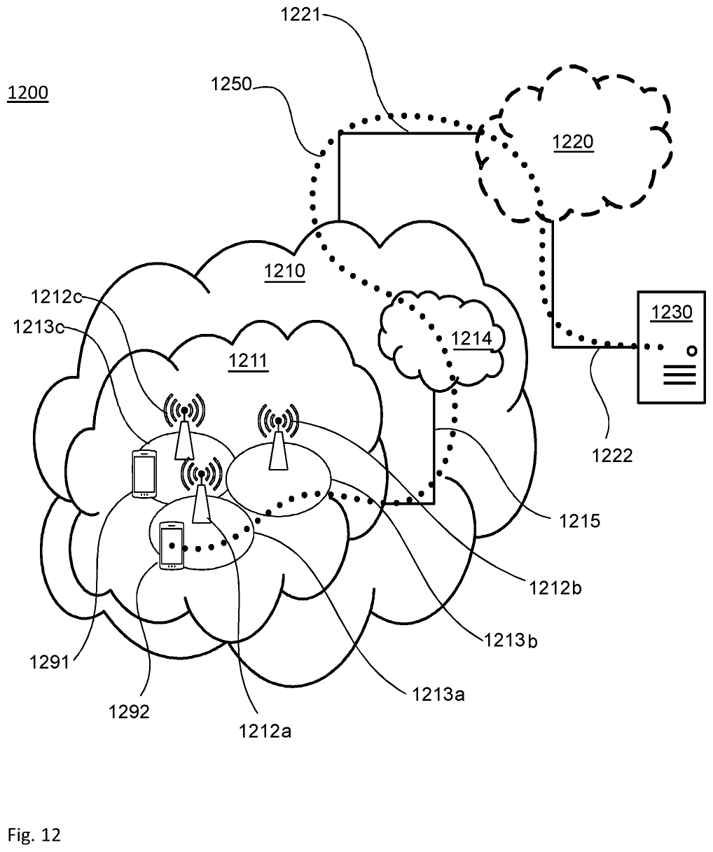

With reference to FIG. 12, in accordance with an embodiment, a communication system 1200 includes a telecommunication network 1210, such as a 3GPP-type cellular network, which comprises an access network 1211, such as a radio access network, and a core network 1214. The access network 1211 comprises a plurality of base stations 1212a, 1212b, 1212c, such as NBs, eNBs, gNBs or other types of wireless access points, each defining a corresponding coverage area 1213a, 1213b, 1213c. Each base station 1212a, 1212b, 1212c is connectable to the core network 1214 over a wired or wireless connection 1215. A first user equipment (UE) 1291 located in coverage area 1213c is configured to wirelessly connect to, or be paged by, the corresponding base station 1212c. A second UE 1292 in coverage area 1213a is wirelessly connectable to the corresponding base station 1212a. While a plurality of UEs 1291, 1292 are illustrated in this example, the disclosed embodiments are equally applicable to a situation where a sole UE is in the coverage area or where a sole UE is connecting to the corresponding base station 1212.

The telecommunication network 1210 is itself connected to a host computer 1230, which may be embodied in the hardware and/or software of a standalone server, a cloud-implemented server, a distributed server or as processing resources in a server farm. The host computer 1230 may be under the ownership or control of a service provider, or may be operated by the service provider or on behalf of the service provider. The connections 1221, 1222 between the telecommunication network 1210 and the host computer 1230 may extend directly from the core network 1214 to the host computer 1230 or may go via an optional intermediate network 1220. The intermediate network 1220 may be one of, or a combination of more than one of, a public, private or hosted network; the intermediate network 1220, if any, may be a backbone network or the Internet; in particular, the intermediate network 1220 may comprise two or more sub-networks (not shown).

The communication system 1200 of FIG. 12 as a whole enables connectivity between one of the connected UEs 1291, 1292 and the host computer 1230. The connectivity may be described as an over-the-top (OTT) connection 1250. The host computer 1230 and the connected UEs 1291, 1292 are configured to communicate data and/or signaling via the OTT connection 1250, using the access network 1211, the core network 1214, any intermediate network 1220 and possible further infrastructure (not shown) as intermediaries. The OTT connection 1250 may be transparent in the sense that the participating communication devices through which the OTT connection 1250 passes are unaware of routing of uplink and downlink communications. For example, a base station 1212 may not or need not be informed about the past routing of an incoming downlink communication with data originating from a host computer 1230 to be forwarded (e.g., handed over) to a connected UE 1291. Similarly, the base station 1212 need not be aware of the future routing of an outgoing uplink communication originating from the UE 1291 towards the host computer 1230.

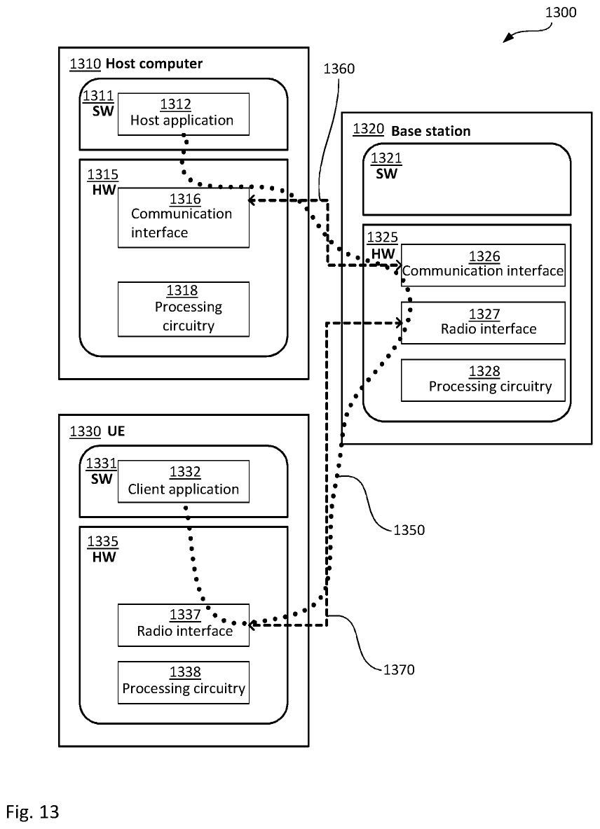

Example implementations, in accordance with an embodiment, of the UE, base station and host computer discussed in the preceding paragraphs will now be described with reference to FIG. 13. In a communication system 1300, a host computer 1310 comprises hardware 1315 including a communication interface 1316 configured to set up and maintain a wired or wireless connection with an interface of a different communication device of the communication system 1300. The host computer 1310 further comprises processing circuitry 1318, which may have storage and/or processing capabilities. In particular, the processing circuitry 1318 may comprise one or more programmable processors, application-specific integrated circuits, field programmable gate arrays or combinations of these (not shown) adapted to execute instructions. The host computer 1310 further comprises software 1311, which is stored in or accessible by the host computer 1310 and executable by the processing circuitry 1318. The software 1311 includes a host application 1312. The host application 1312 may be operable to provide a service to a remote user, such as a UE 1330 connecting via an OTT connection 1350 terminating at the UE 1330 and the host computer 1310. In providing the service to the remote user, the host application 1312 may provide user data, which is transmitted using the OTT connection 1350. The user data may be the data 608.

The communication system 1300 further includes a base station 1320 provided in a telecommunication system and comprising hardware 1325 enabling it to communicate with the host computer 1310 and with the UE 1330. The hardware 1325 may include a communication interface 1326 for setting up and maintaining a wired or wireless connection with an interface of a different communication device of the communication system 1300, as well as a radio interface 1327 for setting up and maintaining at least a wireless connection 1370 with a UE 1330 located in a coverage area (not shown in FIG. 13) served by the base station 1320. The communication interface 1326 may be configured to facilitate a connection 1360 to the host computer 1310. The connection 1360 may be direct or it may pass through a core network (not shown in FIG. 13) of the telecommunication system and/or through one or more intermediate networks outside the telecommunication system. In the embodiment shown, the hardware 1325 of the base station 1320 further includes processing circuitry 1328, which may comprise one or more programmable processors, application-specific integrated circuits, field programmable gate arrays or combinations of these (not shown) adapted to execute instructions. The base station 1320 further has software 1321 stored internally or accessible via an external connection.

The communication system 1300 further includes the UE 1330 already referred to. Its hardware 1335 may include a radio interface 1337 configured to set up and maintain a wireless connection 1370 with a base station serving a coverage area in which the UE 1330 is currently located. The hardware 1335 of the UE 1330 further includes processing circuitry 1338, which may comprise one or more programmable processors, application-specific integrated circuits, field programmable gate arrays or combinations of these (not shown) adapted to execute instructions. The UE 1330 further comprises software 1331, which is stored in or accessible by the UE 1330 and executable by the processing circuitry 1338. The software 1331 includes a client application 1332. The client application 1332 may be operable to provide a service to a human or non-human user via the UE 1330, with the support of the host computer 1310. In the host computer 1310, an executing host application 1312 may communicate with the executing client application 1332 via the OTT connection 1350 terminating at the UE 1330 and the host computer 1310. In providing the service to the user, the client application 1332 may receive request data from the host application 1312 and provide user data in response to the request data. The OTT connection 1350 may transfer both the request data and the user data. The client application 1332 may interact with the user to generate the user data that it provides.

It is noted that the host computer 1310, base station 1320 and UE 1330 illustrated in FIG. 13 may be identical to the host computer 1230, one of the base stations 1212a, 1212b, 1212c and one of the UEs 1291, 1292 of FIG. 12, respectively. This is to say, the inner workings of these entities may be as shown in FIG. 13 and independently, the surrounding network topology may be that of FIG. 12.

In FIG. 13, the OTT connection 1350 has been drawn abstractly to illustrate the communication between the host computer 1310 and the user equipment 1330 via the base station 1320, without explicit reference to any intermediary devices and the precise routing of messages via these devices. Network infrastructure may determine the routing, which it may be configured to hide from the UE 1330 or from the service provider operating the host computer 1310, or both. While the OTT connection 1350 is active, the network infrastructure may further take decisions by which it dynamically changes the routing (e.g., on the basis of load balancing consideration or reconfiguration of the network).

The wireless connection 1370 between the UE 1330 and the base station 1320 is in accordance with the teachings of the embodiments described throughout this disclosure. One or more of the various embodiments improve the performance of OTT services provided to the UE 1330 using the OTT connection 1350, in which the wireless connection 1370 forms the last segment. More precisely, the teachings of these embodiments may reduce the latency and improve the data rate and thereby provide benefits such as better responsiveness.

A measurement procedure may be provided for the purpose of monitoring data rate, latency and other factors on which the one or more embodiments improve. There may further be an optional network functionality for reconfiguring the OTT connection 1350 between the host computer 1310 and UE 1330, in response to variations in the measurement results. The measurement procedure and/or the network functionality for reconfiguring the OTT connection 1350 may be implemented in the software 1311 of the host computer 1310 or in the software 1331 of the UE 1330, or both. In embodiments, sensors (not shown) may be deployed in or in association with communication devices through which the OTT connection 1350 passes; the sensors may participate in the measurement procedure by supplying values of the monitored quantities exemplified above, or supplying values of other physical quantities from which software 1311, 1331 may compute or estimate the monitored quantities. The reconfiguring of the OTT connection 1350 may include message format, retransmission settings, preferred routing etc.; the reconfiguring need not affect the base station 1320, and it may be unknown or imperceptible to the base station 1320. Such procedures and functionalities may be known and practiced in the art. In certain embodiments, measurements may involve proprietary UE signaling facilitating the host computer's 1310 measurements of throughput, propagation times, latency and the like. The measurements may be implemented in that the software 1311, 1331 causes messages to be transmitted, in particular empty or “dummy” messages, using the OTT connection 1350 while it monitors propagation times, errors etc.

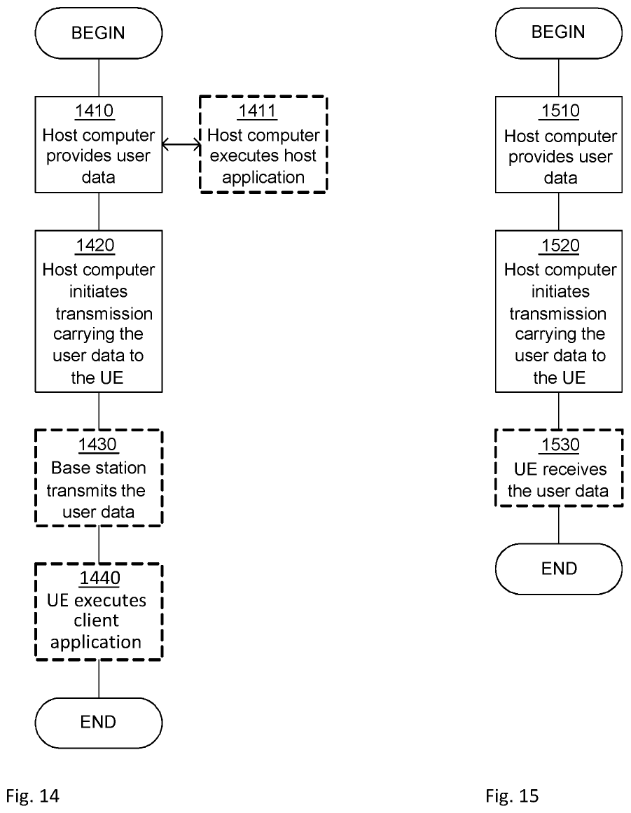

FIG. 14 is a flowchart illustrating a method implemented in a communication system, in accordance with one embodiment. The communication system includes a host computer, a base station and a UE which may be those described with reference to

FIGS. 12 and 13. For simplicity of the present disclosure, only drawing references to FIG. 14 will be included in this section. In a first step 1410 of the method, the host computer provides user data. In an optional substep 1411 of the first step 1410, the host computer provides the user data by executing a host application. In a second step 1420, the host computer initiates a transmission carrying the user data to the

UE. In an optional third step 1430, the base station transmits to the UE the user data which was carried in the transmission that the host computer initiated, in accordance with the teachings of the embodiments described throughout this disclosure. In an optional fourth step 1440, the UE executes a client application associated with the host application executed by the host computer.

FIG. 15 is a flowchart illustrating a method implemented in a communication system, in accordance with one embodiment. The communication system includes a host computer, a base station and a UE, which may be those described with reference to FIGS. 12 and 13. For simplicity of the present disclosure, only drawing references to FIG. 15 will be included in this section. In a first step 1510 of the method, the host computer provides user data. In an optional substep (not shown) the host computer provides the user data by executing a host application. In a second step 1520, the host computer initiates a transmission carrying the user data to the UE. The transmission may pass via the base station, in accordance with the teachings of the embodiments described throughout this disclosure. In an optional third step 1530, the UE receives the user data carried in the transmission.

As has become apparent from above description, embodiments of the technique enable data transmissions on the SL, which satisfy diverse requirements, e.g., in terms of latency, reliability and/or data rate, particularly for different V2X applications. Same or further embodiments may add flexibility to the data transmissions with varied packet sizes.

For example, based on the CSI reports on the SL including multiple RIs and their associated PMIS and/or CQIs, the transmitting UE can select appropriate transmission parameters based on its own needs. For instance, if the transmitting UE targets very high reliability, it may select a precoder associated with a rank equal to 1 based on the CSI report, e.g., to exploit a beamforming gain. Furthermore, if the transmitting UE intends to transmit a small packet, it may select a precoder associated with lower rank (e.g., a rank greater than 1 and less than the maximum of the multiple RIs in the CSI report). Moreover, if the transmitting UE intends to transmit a large packet, it may select a precoder associated with higher rank (e.g., the maximum of the multiple RIs in the CSI report). This flexibility can be particularly beneficial for data traffic involving varying packet sizes.

Embodiments of the technique may enhance the D2D communication (particularly the V2X communication) of 3GPP LTE Release 14 or 15. For example, by virtue of the CSI report, a feedback can be implemented on the SL. Moreover, a multi-antenna transmission on the SL can be enabled based on the CSI report.

The data transmission can be implemented as a unicast or a groupcast transmission on the SL.

The CSI report on the SL can be utilized to improve spectral efficiency and/or transmission reliability. For example, conventionally reporting the maximum possible RI is not suitable for V2X, e.g., since the data of different V2X applications have different requirements. Furthermore, given a certain number of antenna elements, conventionally maximizing the RI can decrease spatial selectivity of the transmission and/or the reception. In contrast, embodiments of the technique can improve frequency reuse and decreases interference.

For an NR implementation of the technique, particularly for V2X communication on the SL, a structure of the CSI report defined for NR eMBB can be reused for the CSI report on the SL.

CSI parameters of the CSI report include the RI. Instead of conventionally reporting a single RI per CSI report as the maximum possible transmission rank of the measured channel, the multiple RIs reported by the technique can enable the transmitting UE to fulfil diverse requirements of its data to be transmitted, e.g., in terms of data rate and/or reliability.

The technique may further be implemented, either independently or in combination with any of the afore-mentioned embodiments, by the below-described further embodiments. Particularly, below “Proposal 4” and/or the paragraph before “Proposal 4” may be implemented independently from other features and proposals.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1-52. (canceled)

53. A method of receiving data on a sidelink (SL) between a receiving radio device and a transmitting radio device, the method comprising:
transmitting a channel state information (CSI) report on the SL to the transmitting radio device, the CSI report comprising multiple rank indicators (RIs), each of the RIs being indicative of a rank for the SL, wherein the multiple ranks indicated in the CSI report comprise all ranks consistent with a rank restriction for the CSI report, wherein the rank restriction is a restriction of the RIs comprised in the CSI report, wherein the rank restriction is defined by a configuration parameter of a configuration applied for the CSI report at the receiving radio device; and
receiving the data from the transmitting radio device on the SL using one of the indicated ranks depending on a requirement of the data.

54. The method of claim 53, wherein the multiple ranks indicated in the CSI report comprise all ranks consistent with:
a rank capability of the receiving radio device; and/or
a rank capability of the transmitting radio device.

55. The method of claim 53, wherein the rank capability of the receiving radio device, the rank capability of the transmitting radio device, and/or the rank restriction for the CSI report is signaled by a radio access network (RAN).

56. The method of claim 53, wherein the rank capability of the receiving radio device, the rank capability of the transmitting radio device, and/or the rank restriction for the CSI report is negotiated between the receiving radio device and the transmitting radio device during an establishing procedure for the SL.

57. The method of claim 53, wherein the requirement of the data comprises or relates to:
a reliability of the data transmission;
a data rate of the data transmission;
a latency of the data transmission;
a packet size of the data; and/or
an inter-arrival time of the data at the transmitting radio device.

58. The method of claim 53, further comprising receiving SL control information (SCI) from the transmitting radio device, the SCI being indicative of the rank among the indicated ranks, which is used for the data on the SL.

59. The method of claim 53, wherein the CSI report is further indicative of a set of one or more CSI parameters for the SL in association with at least one or each of the multiple RIs in the CSI report.

60. The method of claim 59, wherein each of the sets of one or more CSI parameters is calculated conditioned on the respectively indicated rank.

61. The method of claim 59, wherein the one or more CSI parameters of one or each of the sets comprise a precoding matrix indicator (PMI) and/or a channel quality indicator (CQI).

62. The method of claim 61, wherein each of the PMI and the CQI is calculated conditioned on the respectively indicated rank.

63. A method of transmitting data on a sidelink (SL) between a receiving radio device and a transmitting radio device, the method comprising:
receiving a channel state information (CSI) report on the SL from the receiving radio device, the CSI report comprising multiple rank indicators (RIs), each of the RIs being indicative of a rank for the SL, wherein the multiple ranks indicated in the CSI report comprise all ranks consistent with a rank restriction for the CSI report, wherein the rank restriction is a restriction of the RIs comprised in the CSI report, wherein the rank restriction is defined by a configuration parameter of a configuration applied for the CSI report at the receiving radio device; and
transmitting the data to the receiving radio device on the SL using one of the indicated ranks depending on a requirement of the data.

64. The method of claim 63, wherein the multiple ranks indicated in the CSI report comprise all ranks consistent with:
a rank capability of the receiving radio device; and/or
a rank capability of the transmitting radio device.

65. The method of claim 63, wherein the transmitting radio device determines the requirement of the data based on the data becoming available at the transmitting radio device for the transmission or in response to the data becoming available at the transmitting radio device for the transmission.

66. The method of claim 63, wherein the requirement of the data comprises or relates to:
a reliability of the data transmission;
a data rate of the data transmission;
a latency of the data transmission;
a packet size of the data; and/or
an inter-arrival time of the data at the transmitting radio device.

67. The method of claim 63, further comprising transmitting SL control information (SCI) to the receiving radio device, the SCI being indicative of the rank among the indicated ranks, which is used for the data on the SL.

68. The method of claim 63, wherein the CSI report is further indicative of a set of one or more CSI parameters for the SL in association with at least one or each of the multiple RIs in the CSI report.

69. The method of claim 68, wherein each of the sets of one or more CSI parameters is calculated conditioned on the respectively indicated rank.

70. The method of claim 68, wherein the one or more CSI parameters of one or each of the sets comprise a precoding matrix indicator (PMI) and/or a channel quality indicator (CQI).

71. A device for receiving data on a sidelink (SL) between a receiving radio device and a transmitting radio device, the device comprising:
processing circuitry;
memory containing instructions executable by the processing circuitry whereby the device is operative to:
transmit a channel state information (CSI) report on the SL to the transmitting radio device, the CSI report comprising multiple rank indicators (RIs), each of the RIs being indicative of a rank for the SL, wherein the multiple ranks indicated in the CSI report comprise all ranks consistent with a rank restriction for the CSI report, wherein the rank restriction is a restriction of the RIs comprised in the CSI report, wherein the rank restriction is defined by a configuration parameter of a configuration applied for the CSI report at the receiving radio device; and
receive the data from the transmitting radio device on the SL using one of the indicated ranks depending on a requirement of the data.

72. A device for transmitting data on a sidelink (SL) between a receiving radio device and a transmitting radio device, the device comprising:
processing circuitry;
memory containing instructions executable by the processing circuitry whereby the device is operative to:
receive a channel state information (CSI) report on the SL from the receiving radio device, the CSI report comprising multiple rank indicators (RIs), each of the RIs being indicative of a rank for the SL, wherein the multiple ranks indicated in the CSI report comprise all ranks consistent with a rank restriction for the CSI report, wherein the rank restriction is a restriction of the RIs comprised in the CSI report, wherein the rank restriction is defined by a configuration parameter of a configuration applied for the CSI report at the receiving radio device; and
transmit the data to the receiving radio device on the SL using one of the indicated ranks depending on a requirement of the data.
